(19) United States
(12) Patent Application Publication
(10) Pub. No.: US 2021/0089974 A1
(43) Pub. Date: Mar. 25, 2021

(54) SYSTEM AND METHOD FOR ANALYZING RELATIONSHIP RETURN ON MARKETING INVESTMENTS AND BEST MARKETING EVENT SELECTION

(71) Applicant: Introhive Services Inc., Fredericton (CA)

(72) Inventors: David HUDSON, Fredericton (CA); Peter MCGAW, Fredericton (CA); Sophie GADD, Keswick Ridge (CA); Lucas POND, New Maryland (CA)

(21) Appl. No.: 17/027,492

(22) Filed: Sep. 21, 2020

Related U.S. Application Data
(60) Provisional application No. 62/903,455, filed on Sep. 20, 2019.
(60) Provisional application No. 62/947,912, filed on Dec. 13, 2019.

(51) Int. Cl. G06Q 10/02; G06N 20/00; G06F 16/9536; H04L 12/18

(52) U.S. Cl. CPC G06Q 10/02; G06N 20/00; H04L 12/1831; H04L 12/1818; G06F 16/9536

(57) ABSTRACT

Method and system for determining one or more performance metrics for events that an enterprise participates in, including: receiving data identifying individual contacts that attended an event; computing, for each of the individual contacts, a difference in an individual relationship score for the individual contact at a time following the event relative to a time preceding the event, wherein the individual relationship score is based on automated tracking of communication activities occurring between the individual contact and individual users associated with the enterprise; computing a first event performance metric for the event based on the computed differences in the individual relationship scores for the individual contacts; and storing the first performance metric for the event.

### CROSS-REFERENCE TO RELATED APPLICATION

This application claims the benefit of and priority to the following application, the contents of which are incorporated herein by reference: U.S. Provisional Patent Application No. 62/903,455 entitled SYSTEM AND METHOD FOR ANALYZING RELATIONSHIP RETURN ON MARKETING INVESTMENTS filed Sep. 20, 2019 and U.S. Provisional Patent Application No. 62/947,912 entitled SYSTEM AND METHOD FOR ANALYZING RELATIONSHIP RETURN ON MARKETING INVESTMENTS AND BEST MARKETING EVENT SELECTION filed Dec. 13, 2019.

### TECHNICAL FIELD

The present disclosure relates to systems and methods for analysis of data from Customer Relationship Management (CRM) Systems and computing the marketing Return on Investment (ROI) on events.

### BACKGROUND

Enterprises such as companies, accounting firms, law firms, universities, partnerships, agencies and governments commonly use CRM systems and related technology to manage relationships, interactions and opportunities with other parties such as customers and potential customers.

One of the challenges today is determining the ROI for marketing expenditures for events, as quantifying all of the possible ‘returns’ from a marketing event contains many intangibles.

One of the problems is determining an accurate gauge of the true return on the time and effort invested into various marketing events. There are solutions today that calculate the monetary return based on the monetary investment in creating and running a marketing event. There is value added for an enterprise from marketing events that cannot be measured in a strict monetary manner. These marketing events may be the catalyst for new contact relationships, but these relationships often take time to grow before there is any monetary return. Some events may greatly increase the relationship with an existing contact in a very positive manner and a second event may occur before a formal opportunity is realized, further complicating the calculation of a purely monetary ROI. With today's solutions, the ROI would all be attributed to the second event.

Another problem is that without being able to determine the full value (monetary and intangible assets) returned from a specific marketing event, it is difficult to compare different types of marketing events to identify the best type of event to invest in.

Another problem is that specific Contacts and certain roles\title levels may prefer one event type over another, and this may change from contact to contact and account to account.

Accordingly, there is a requirement for better methods and systems for collecting and processing data related to events.

### SUMMARY

According to a first example aspect of the present disclosure is a computer implemented method for determining one or more performance metrics for events that an enterprise participates in. The method includes: receiving data identifying individual contacts that attended an event; computing, for each of the individual contacts, a difference in an individual relationship score for the individual contact at a time following the event relative to a time preceding the event, wherein the individual relationship score is based on automated tracking of communication activities occurring between the individual contact and individual users associated with the enterprise; computing a first event performance metric for the event based on the computed differences in the individual relationship scores for the individual contacts; and storing the first performance metric for the event.

In some examples of the first aspect, the method includes: identifying which of the individual contacts that attended the event are new contacts that can be attributed to the event; computing a new contact score for the event based on the identified new contacts.

In some examples of the first aspect, the new contact score is computed based on both a total number of the identified new contacts and on positions of the identified new contacts within their respective organizations.

In some examples of the first aspect, the first performance metric is indicative of a perceived return on investment of the event and is computed also based on the new contact score.

In some examples of the first aspect, the first performance metric corresponds to a relationship change score, the new contact score corresponds to a second performance metric for the event; and the method comprises computing and storing a third performance metric indicative of a perceived return on investment of the event based on the relationship change score and the new contact score computed in respect of the event.

In some examples of the first aspect, the method comprises identifying, based on information about ongoing opportunities of the enterprise that are stored in a database, which of the opportunities are associated with individual contacts that attended the event, determining changes in a status of the identified opportunities following the event, and computing an opportunity score based on the determined changes.

In some examples of the first aspect, the method further includes receiving a set of event attributes in respect of a proposed future event; computing, based on (i) event data for a plurality of historic events that includes one or more performance metrics for each of the historic events and event type information for each of the historic events; and (ii) the set of event attributes, a recommended event type for the proposed future event.

In some examples of the first aspect, the method includes computing, based on event data for a plurality of historic events, event types that are preferred by contacts within different industry classifications, and computing a recommended event type for a proposed future event based on an indicated target industry classification for the proposed future event.

In some examples of the first aspect, the events include one or more of: marketing events that are organized by the enterprise and third party events that individual users associated with enterprise participate in, and the contacts are associated with accounts of the enterprise.

In some examples of the first aspect, the method includes automatically monitoring occurrences of electronic communications between individual users and the individual contacts over time to track the communication activities occurring between the individual contacts and the individual users.

According to a further example aspect is a system for determining one or more performance metrics for events that an enterprise participates in, the system comprising a processor and non-transitory storage medium coupled to the processor, the storage medium storing software instructions that when executed by the processor configure the system to perform one or more of the above methods.

According to a further example aspect is a system for determining one or more performance metrics for events that an enterprise participates in, the system comprising a processor and non-transitory storage medium coupled to the processor, the storage medium storing software instructions that when executed by the processor configure the system to: receive data identifying individual contacts that attended an event; compute, for each of the individual contacts, a difference in an individual relationship score for the individual contact at a time following the event relative to a time preceding the event, wherein the individual relationship score is based on automated tracking of communication activities occurring between the individual contact and individual users associated with the enterprise; compute a first event performance metric for the event based on the computed differences in the individual relationship scores for the individual contacts; and store the first performance metric for the event.

### BRIEF DESCRIPTION OF DRAWINGS

Exemplary embodiments are illustrated in the referenced FIG.s of the drawings. It is intended that the embodiments and FIG.s disclosed herein are to be considered illustrative rather than restrictive.

FIG. 1 is a simplified block diagram illustrating an environment that includes an enterprise network, a CRM system, and a CRM support system in accordance with example embodiments of the present disclosure.

FIG. 2 is a flow diagram illustrating the steps taken by an ROI analysis module included within the environment of FIG. 1.

FIG. 3 illustrates reports generated by the ROI analysis module.

FIG. 4 is a flow diagram illustrating further steps taken by the ROI analysis module.

FIG. 5 is a simplified block diagram illustrating an example computer system for implementing one or more of the systems, modules and components shown in the environment of FIG. 1.

### DESCRIPTION

The following embodiments and aspects thereof are described and illustrated in conjunction with systems, tools and methods which are meant to be exemplary and illustrative, not limiting in scope. In various embodiments, the above-described problem has been reduced or eliminated, while other embodiments are directed to other improvements.

The embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Example embodiments are directed to computer implemented systems and methods for improving identification of relationship ROI of a marketing event by utilizing the relationship database and the contact information in the CRM to determine non-monetary metrics that may be allocated to an event, including for example new relationships with contacts and change in relationship strengths with contacts. The example embodiment utilizes the marketing event data to attribute the new/growing relationships to.

Example embodiments are directed to computer implemented systems and methods that are configured to review marketing event data collected in respect of a marketing event and determine which contacts were made as a result of the marketing event. This determination is made by, but not limited to, business contacts entered as a result of the marketing event, new contacts made via web site sign-ups for the event or via the marketing event registration process.

In at least some example embodiments, the automated systems disclosed will identify the increase (or decrease) in relationship strengths for a specified period of time after the marketing event. Any change within this period of time will be attributed to the event and used in the determination of the event value.

In example embodiments, computer implemented systems and methods provide the results of all of the individual marketing events and an analysis of the increase in new contacts, increase in relationship strength of existing contacts, as well as relationship strength change for the new contacts made due to the marketing event. This information will allow a determination to be made, for example but not limited to, of which type of event has proven to result in the most new contacts, which has proven to result in the most positive increase in relationship strength, and which type of event results in the most growth of new contacts made.

In example embodiments, computer implemented systems and methods will monitor which type of event each contact responds to/accepts/attends in order to identify the preferences of that specific contact.

In example embodiments, computer implemented systems and methods will also monitor the types of event that contacts in various positions (e.g., as represented by title score), from various industries (e.g., as represented by an industry type code) acknowledge (e.g., accept an invitation to) and attend in order to generally track the event type preferences for: (i) contacts holding certain positions; and (iii) contacts in certain industries, both within an account and across all enterprise accounts.

The information provided using the systems and methods of example embodiments may allow an enterprise to determine which type of marketing event should be arranged depending on the specific result that the enterprise is attempting to achieve.

In some embodiments, the methods and systems may provide output that would correlate the relationship changes from the marketing events with opportunity creation and eventual successful opportunity closures.

In at least some example embodiments, the automated systems disclosed herein may reduce the amount of interaction required between a computer system (e.g. with a CRM system) and an individual than might otherwise be required to discover the same, or less accurate information, using traditional CRM based approaches. This may in turn reduce the computational resources and/or use (and thus wear-and-tear and depreciation) of user-computer interfaces and/or user resources that could otherwise be required in the absence of the presently disclosed solutions.

The foregoing examples of the method are intended to be illustrative and not exclusive. Other methods will become apparent to those of skill in the art upon a reading of the specification and a study of the drawing.

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

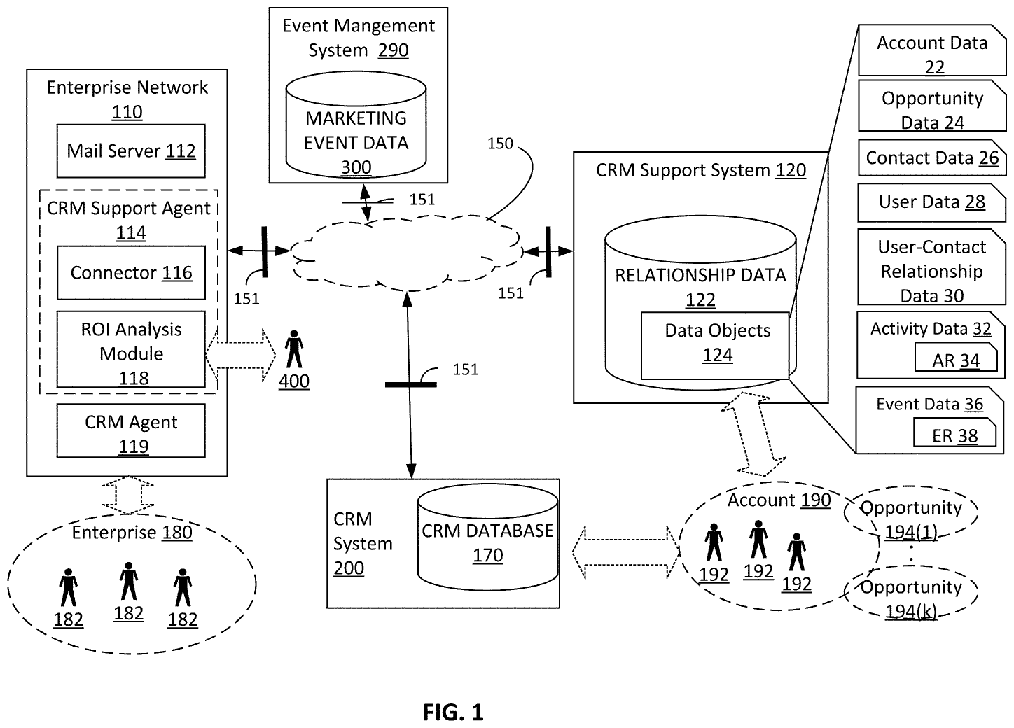

FIG. 1 illustrates an example environment in which the methods and systems described in this disclosure may be implemented. In the example of FIG. 1, environment includes an enterprise network 110 that supports an enterprise such as a company, firm or other type of organization (referred to in this disclosure as “enterprise 180”). In example embodiments, a plurality of individuals are registered or otherwise associated with the enterprise network 110 as users 182 of the enterprise 180. These individual users 182 may for example be employees, owners, partners, consultants, volunteers, and interns of the enterprise 180. In some examples, enterprise 180 could have as few as one user 182, and in some examples, enterprise 180 may have thousands or more users 182.

At any given time the enterprise 180 has, or is, pursuing commercial relationships with one or more external entities or third party organizations, referred to in this disclosure as “accounts” 190. For example, such external entities could be existing or potential customers, clients or donors or other entities of interest to the enterprise, and may include, among other things, companies, partnerships, universities, firms, government entities, joint venture groups, non-government organizations, charities and other types of groups. Typically, each account 190 will have an associated set of individual contacts, referred to in this disclosure as “contacts” 192, that are identified as contacts of the enterprise 180 in one or more electronic databases that are operated by or associated with enterprise 180. For example, the individual contacts 192 associated with an account 190 may be employees, owners, partners, consultants, volunteers, and interns of the account 190. Furthermore, at any given time the enterprise 180 will typically have completed or will be pursuing one or more opportunities 194(1) to 194(k) (with k being account dependent and representing a total number of open and closed opportunities with a specific account 190). In this disclosure, the reference “opportunity 194(j)” will be used to refer a generic individual opportunity with an account 190, and “opportunities 194” used to refer to a generic group of opportunities. An opportunity 194(j) may for example be a sales opportunity to sell a product or service, and may have an opportunity lifetime (e.g., duration of time from recognition of existence of the opportunity to closing of the opportunity) that can be divided into a set of successive stages or phases such as the seven basic stages of a sales cycle (e.g., Prospecting, Preparation, Approach, Presentation, Handling objections, Closing).

Enterprise network 110 may, for example, include a plurality of computer devices, servers and computer systems that are associated with the enterprise 180 and are linked to each other through one or more internal or external communication networks, at least some of which may implement one or more virtual private networks (VPN).

In example embodiments, the environment of FIG. 1 also includes a CRM support system 120, an event management system 290 and a CRM system 200, each of which may also include one or more computer devices, servers and network systems. One or more of CRM support system 120, CRM system 200 and event management system 290 may, in some examples, be operated by third party organizations that are service providers to the enterprise 180 associated with enterprise network 110. CRM support system 120 and a CRM system 200 are configured to track customer data (e.g., account data) on behalf of enterprise 180. In example embodiments, event management system 290 is configured to track information about events that the enterprise network 110 participates in or hosts for the benefit of improving relationships with account contacts 192. In example embodiments, the event management system 290 includes a marketing event data database 300 for storing information about events.

In the illustrated example, enterprise network 110, CRM support system 120, event management system 290, and CRM system 200 are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 110, event management system 290, CRM support system 120, event management system 290, and CRM system 200. In different example embodiments, one or more of the features or functions of CRM support system 120, event management system 290 and CRM system 200 that are described herein could be alternatively be implemented in a common system or implemented within the enterprise network 110. For example, event management system 290 and CRM support system 120 may, in some examples, be located within enterprise network 110 in example embodiments. In some examples, some or all or the modules or systems included in FIG. 1 as part of enterprise network 110 could be remotely hosted and accessed by users of the enterprise network 110 through network 150.

Enterprise network 110 includes at least one mail server 112 for handling and delivering external email that enterprise network 110 exchanges with remote mail servers through communication network 150. Thus, mail server 112 contains emails sent/received by the enterprise associated with enterprise network 110. In some examples, mail server 112 may also handle internal emails that are internal within enterprise network 110.

In example embodiments, enterprise network 110 includes a CRM agent 119 that provides the enterprise network 110 with an interface to CRM system 200.

In example embodiments, enterprise network 110 also includes a CRM support agent 114 that provides the enterprise network 110 with an interface to CRM support system 120. In example embodiments, CRM support agent 114 includes a connector 116 and a ROI analysis module 118. In some examples, some of the functionality of CRM support agent 114 could be remotely hosted at a system or network that is not part of enterprise network 110. For example, some or all of the functionality of ROI analysis module 118 could be hosted at CRM support system 120. The locations of various modules, systems and databases as shown in FIG. 1 is illustrative of only one of many possible architecture configurations.

As described in greater detail below, connector 116 is configured to interact with systems within the enterprise network 110 (such as mail server 112) to extract information about activities (such as communication activities) and provide that information to CRM support system 120. As will also be described in greater detail below, ROI analysis module 118 is configured to interact with CRM system 200, event management system 290, and CRM support system 120 to provide, among other things, intelligent information about which marketing event is providing the best ROI when measured by relationship gains (either new or increases in existing relationships) and which marketing event each contact would most likely be responsive to.

In example embodiments, CRM system 200 may be implemented using a known CRM solution such as, but not limited to, Salesforce.com™, Microsoft Dynamics™, InterAction™ or Maximizer™, and includes a CRM database 170 that includes customer data (e.g., CRM data) for accounts 190 is desirous of tracking. The CRM data that is stored in a CRM database 170 for an account 190 may for example include: (I) general account data, (II) opportunity data about specific opportunities that the enterprise has undertaken in the past, is currently undertaking, or is proposing to undertake in the future with accounts 190, and (III) individual contact data that includes contact information for individual contacts who are members of the accounts 190.

Event Management System 290

In example embodiments, event management system 290 is configured to track data about marketing events that are planned for the future and that have already occurred. The data stored in marketing event database 300 of event management system 290 may include, for each of a plurality of marketing events, records that include some or all of the fields listed in the following Table A, among other things:

TABLE A
Marketing Event Data Fields:

| Field | Field Description |
|---|---|
| Event ID | Unique event identifier |
| Event Name‥ | Name assigned to event |
| Event Type | Marketing Event type: |
| | Trade Show |
| | Conference |
| | Webinar |
| | Mail Outs |
| | Open House |
| | Wine'n'Cheese |
| | Lunch'n'Learn |
| | Breakfast Briefing |
| | Round Table |
| Event Date | Date of the event |
| Invitation Date | Date or range of dates during which |
| | event invitations were distributed |
| | (e.g., by email or social media) |
| Registration Date | Date or range of dates during which |
| | event registrations were received |
| Event Cost | Total monetary cost of the event |
| | (Can be broken into subcategories) |
| Event Coordinator | ID of enterprise User responsible for |
| | event |
| Event Invitees | List of invitees that were invited to |
| | an event. Invitees are each |
| | identified in the list by Unique |
| | Identifiers (Unique Identifiers may |
| | for example include one or more of |
| | invitee name, invitee email, Contact |
| | ID (if known), or other identifier |
| | than can be cross referenced or |
| | mapped to unique identifying |
| | information for contacts that are |
| | recorded in relationship data storage |
| | 122 and/or CRM database 170.) |
| | Each Unique Identifier can also be |
| | associated with a time stamp |
| | indicating date/time the invitation |
| | was provided and a invitation |
| | medium identifier indicating how the |
| | invitation was provided (e.g., by |
| | email, through social media, by |
| | regular email, in-person.) |
| Event Registrants | List of Unique Identifiers for |
| | individuals who registered for the |
| | event (for example responded to an |
| | invite, or signed up through a web- |
| | interface or other registration |
| | mechanism). Each Unique Identifier |
| | can also be associated with a time |
| | stamp indicating date/time the |
| | registration occurred and a |
| | registration medium identifier |
| | indicating how the registration was |
| | invitation was performed (e.g., by |
| | email, through web-registration, by |
| | phone, by fax) |
| Event Attendees | List of Unique Identifiers for |
| | individuals who are confirmed as |
| | having attended the event. In some |
| | scenarios, attendance may be virtual |
| | (e.g., webinar), and in some |
| | scenarios, attendance may be in- |
| | person (e.g., breakfast briefing) |
| Project Type | Type of project the marketing event |
| | is intended to promote (e.g., |
| | product launch, partner enablement, |
| | new vertical entry, fundraiser, |
| | generally increase contacts). |
| Total number of Invitees | Total number of Contacts Invited to |
| | the event |
| Total number of Registrants | Total number of Contacts who |
| | registered for the event through |
| | RSVP or other means |
| Total number of Attendees | Total number of Attendees for Event |
| Industry Code(s) | Specifies the codes of the industry |
| | or industries that the event targets |
| | (e.g., Standard Industrial |
| | Classification (SIC) code and/or |
| | North American Industry |
| | Classification System (NAICS) |
| | codes) |

In example embodiments, the event management system 290 may be a basic computer-aided system wherein marketing event database 300 comprises a set of electronic spreadsheets (E.g. Excel™ spreadsheets) that are populated through conventional data input by marketing personal. In some example embodiments, event management system 290 may include one or more automated features that can facilitate invitation generation and tracking of the event data noted above. In some examples, event management system 290 may be configured to interface with one or more of the databases and data storages of enterprise network 110, CRM support system 120 and CRM system 200 to exchange information and map individuals included in invitee, attendee and registrant lists to contacts identified in such databases and data storages.

CRM Support System 120

In example embodiments, CRM support system 120 is configured to provide enhanced CRM information and functionality that supplements CRM System 200. CRM support system 120 includes a relationship data storage 122 for storing relationship data generated in respect of the accounts 190 of interest to enterprise 180. In example embodiments, similar to CRM database 170, relationship data storage 122 may store, in respect of each account 190, relationship data objects 101 that include: (I) account data 22 that provides general information about the account 190, (II) opportunity data 24 about specific opportunities that the enterprise has undertaken in the past, is currently undertaking, or is proposing to undertake in the future with the account 190, (III) individual contact data 26 that includes contact information for individual contacts 192 (e.g., employees) who are associated with the account 190, (IV) user data 28, that includes information about enterprise users 182 who are involved in the relationship with an account 190, (V) user-contact relationship strength data 30, (VI) activity data 32 that includes information about activities between enterprise 180 and account 190. In example embodiments, the data objects 124 also includes event data 36 that includes data that is similar to, and further supplements, event data included in marketing event database 300 of event management system 290. The data in relationship data storage 122 may include some or all of the information stored at CRM database 170, as well as supplemental information.

In example embodiments, the CRM Support System 120 interfaces with connector 116 of CRM support agent 114 and other possible data sources to collect and update of data stored in relationship data storage 122. In some examples, the CRM support system 120 is configured to periodically refresh (e.g., for example on a timed cycle such as once every 24 hours) the content of data objects 124 such that the data maintained in relationship data storage 122 always includes current or near-current information. The CRM support system 120 may periodically refresh the information stored in relationship data storage 122 based on information from a plurality of sources. For example, CRM support system 120 may obtain data from the CRM database 170 of CRM system 200, from enterprise network 110, as well as from other data sources that are available through communication network 150, including for example marketing event database 300 of event management system 290.

Account data 22: In example embodiments, the basic data included in account data 22 stored at relationship data storage 122 may include, for each account 190, some or all of the fields listed in the following Table 1, among other things:

TABLE 1
Account Data Fields:

| Field | Field Description |
|---|---|
| Enterprise ID | Unique identifier assigned to |
| | Enterprise 180 |
| Account ID | Unique identifier assigned to |
| | Account 190 |
| Account Industry Code | Code that identifies primary industry |
| | type of customer organization (e.g., |
| | Standard Industrial Classification |
| | (SIC) Code and/or North American |
| | Industry Classification System |
| | (NAICS) Codes) |
| Number of Employees | Number of Employees of Account |
| | Organization |
| Account Size Score | Score assigned based on size of |
| | account organization (e.g., |
| | organization size of 1500+ |
| | employees = 10 points; 1000 to |
| | 1500 = 9 points; 750-1000 = 8 |
| | points, etc.) |
| Account Annual Revenue | Annual Revenue of account |
| | organization for one or more |
| | previous years |
| Owner User ID | User ID of enterprise user 182 who |
| | owns the account (e.g., user 182 |
| | who has primary responsibility for |
| | enterprise-account relationship) |
| Name | Name of Account (e.g., company |
| | name) |
| Top User-Account Relationship | The enterprise user 182 that has the |
| | strongest relationship with the |
| | account 190 |
| Account Active/Inactive Indicator | Indicates that Account is currently |
| | an active account of the enterprise |
| | or currently inactive |

The fields “Account Active Indicator” can be used for an indicator that indicates if an account is currently active or is not currently active (e.g., inactive). In some embodiments, an active account is an account 190 that the enterprise 180 currently has an open opportunity with, or is a current customer or client, or has been a customer or client within a predefined prior time duration (e.g., within last year). In some examples, inactive accounts can be classified as historic accounts or prospective accounts. Inactive historic accounts may for example be previously active accounts that have been dormant (e.g., no open opportunities and currently not a current customer or client) for greater than a predefined prior time duration (e.g., more than one year). Inactive prospective accounts may for example be potential accounts that were never active but that are of interest to enterprise 180, for example organizations in an industry of interest to the enterprise 180, but whom the enterprise has not yet started prospecting.

Opportunity data 24: In example embodiments, the basic data included in opportunity data 24 stored at relationship data storage 122 may include, for each opportunity with each account 190, opportunity records that include some or all of the fields listed in the following Table:

TABLE 2
Opportunity Data Fields:

| Field | Field Description |
|---|---|
| Opportunity ID | Unique identifier assigned to |
| | Opportunity |
| Account ID | Account ID of the account that is the |
| | target of the opportunity |
| Created Date | Date opportunity registered with |
| | CRM support system |
| Closed Indicator | Indicates if opportunity is closed |
| Closed Date | Date Opportunity was closed |
| Current Phase | Indicates current phase of open |
| | opportunity (e.g., Prospecting, |
| | Preparation, Approach, Presentation, |
| | Handling objections, Closing) |
| Won Indicator | Indicates opportunity closed |
| | successfully (e.g., with a sale) |
| Opportunity Size Score | Score that represents a size or dollar |
| | value of the opportunity |
| Main Contact ID | Contact ID of lead contact for |
| | opportunity with the account |
| Main User ID | Contact ID of lead user for |
| | opportunity |
| Last Activity Date | Date of most recent activity |
| | recorded in respect of opportunity |
| Event ID | ID of marketing event that resulted |
| | in Opportunity (if known) |

Contact data 26: In example embodiments, the basic data included in contact data 26 stored at relationship data storage 122 may include, for each contact 192 at account 190, contact records that include some or all of the fields listed in the following Table 3, among other things:

TABLE 3
Contact Data Fields:

| Field | Field Description |
|---|---|
| Contact ID | Unique contact identifier |
| Active/Inactive Indicator | Indicates if contact is active or |
| | inactive |
| Date Created | Date contact added |
| Account ID | Account ID of the account the |
| | contact is associated with (referred |
| | to as “contact's account”) |
| Department | Name of contact's department in |
| | contact's account |
| Account Industry Code | Industry Code for contact's account |
| Position/Title | The position/title of the contact in |
| | contact's organization |
| Title Score | Hierarchal Score assigned to Contact |
| | based on contact's position at |
| | contact's organization (e.g., may be |
| | defined by a look up table that maps |
| | position titles to scores: president = |
| | 20 points, CEO = 20 points, VP = 18 |
| | points, senior manager = 14 points; |
| | partner = 16 points, etc.) |
| Contact-Enterprise Relationship | Score That Indicates Perceived |
| Score | Value of the Relationship with the |
| | Contact |
| First Name | Contact's First Name |
| Last Name | Contact's Last Name |
| Full Name | Contact's Full Name |
| Primary Email | Contact's Primary Email |
| Primary Phone | Contact's Primary Phone |
| Preferred Marketing Event | Preferred Event Type for Contact |
| Contact Origination Type | Type and ID of activity or event that |
| | caused contact to be added as an |
| | Active Contact (e.g., email |
| | communication activity, meeting |
| | communication activity, new outlook |
| | or other personal information |
| | management system contact |
| | addition) |
| Image | One or more images obtained from |
| | on-line sources (e.g., Linked-In ™ |
| | profile picture) |

As noted above, contacts can be indicated as active or inactive. In example embodiments, an active contact can be a contact that has been a party to an activity (as tracked in activity data 32 below) within a predefined prior time period (e.g., last 18 months) and/or meets other pre-defined criteria including for example criteria as set by privacy and solicitation legislation or regulations. Inactive contacts are contacts that are not currently active and may in some examples be classified in one or more categories such as inactive historic contacts (e.g., contacts that were previously active contacts, and inactive prospective contacts (e.g., contacts working in industries that are of interest to the enterprise or with active accounts, but who are not historic contacts).

User data 28: In example embodiments, the basic data included in user data 28 stored at relationship data storage 122 may include, for each user 182 that has a relationship with a contact 192 at the account 190, user records that include some or all of the fields listed in the following Table 4, among other things:

TABLE 4
User Data Fields:

| Field | Field Description |
|---|---|
| User ID | Unique user identifier |
| Account ID | Account ID of the subject account |
| Department | Name of user's department in the |
| | enterprise organization |
| Title | Title/position of user within |
| | enterprise organization |
| User-Account Relationship Score(*) | Score That Indicates Perceived |
| | Value of User's Relationship With |
| | Account |
| Opportunity ID(*) | Opportunity ID for opportunity for |
| | which user is member of the |
| | enterprise team (e.g., selling team) |

(*)indicates fields that can be repeated for multiple accounts/opportunities

User-Contact Relationship Data 30: In example embodiments, the basic data included in user-contact relationship data 30 stored at relationship data storage 122 includes information for each known user-contact relationship that exists between a user 182 within enterprise 180 and a contact 192 within an account 190. User-contact relationship records included in user-contact relationship data 30 may for example include some or all of the fields listed in the following Table 5, among other things:

TABLE 5
User-Contact Relationship Data Fields:

| Field | Field Descriotion |
|---|---|
| User ID | Unique user identifier |
| Contact ID | Contact Unique Identifier |
| Account ID | Contact's Account |
| Start Date | Date when relationship between |
| | user and contact started |
| Relationship Origination Indicator | Activity ID and/or event ID of the |
| | activity/event that first triggered |
| | Contact/user relationship |
| Active Indicator | Indicates if relationship is currently |
| | active |
| User-Contact Relationship Score | Score that indicates perceived |
| | strength of User-Contact |
| | Relationship Strength |
| Last Activity Date | Date of last recorded activity |
| | including user and contact |

Activity data 32: In example embodiments, the activity data 32 stored at relationship data storage 122 may include data for activities related to the entity-account relationship. Activities may for example include communication activities and documentation activities among other things. Activity data 32 may include respective activity records 34 for each logged activity. Each activity record 34 may include, depending on the type of activity and availability of information, the fields listed in the following Table 6, among other things:

TABLE 6
Activity Data Fields:

| Field | Field Description |
|---|---|
| Activity ID | Unique identifier assigned to activity |
| Account ID | Identity of Account whose contacts |
| | participated in the activity |
| Opportunity ID | Identity of the opportunity that |
| | activity related to |
| Activity Type Indicator | Value that identifies the type of |
| | activity (e.g., (i) communication |
| | activity: incoming email, outgoing |
| | email, incoming meeting request, |
| | outgoing meeting request, incoming |
| | phone call, outgoing phone call, in- |
| | person meeting, virtual meeting, (ii) |
| | documentation activity: proposal |
| | submitted, draft statement of work |
| | (SOW) submitted; final SOW |
| | submitted; contract submitted for |
| | review). |
| Document ID | ID of document template (can be |
| | used to identify content of standard |
| | form email in the form of a |
| | communication action, or to identify |
| | document template in case of |
| | documentation activity) |
| Start Time | Date and time stamp indicating start |
| | of activity |
| Activity Duration | Duration of activity (e.g., length of |
| | meeting or phone call) |
| Sentiment Indicator | Indicator provided manually or by |
| | natural language processing |
| | algorithm as to sentiment of activity |
| | (e.g.: negative to positive sentiment |
| | on scale of 1 to 5, in example |
| | embodiments, may be determined at |
| | CRM support agent 114 and sent by |
| | connector 116 to data tracking |
| | module 122) |
| Content Count* | Counts number of occurrences of |
| | predefined words in communication |
| | activity (e.g., product name, |
| | competitor product name). (In |
| | example embodiments, may be |
| | determined at CRM support agent |
| | 114 and sent by connector 116 to |
| | data tracking module 122) |
| Participants - Account* | Contact IDs or other available |
| | identifier for all parties involved on |
| | account side of activity |
| Participants - Enterprise* | User IDs or other available identifier |
| | for all parties involved on enterprise |
| | side of activity |

*Indicates fields that will be repeated as required

Event data 36: In example embodiments, the event activity data 36 stored at relationship data storage 122 may include data for marketing event that Enterprise 180 participates in. Event data 36 may include respective event records 38 for each marketing event. Each event record 38 may include, depending on the type of event and availability of information, some or all or the fields included in Table A above, as well as supplemental data listed in the following Table 7, among other things:

TABLE 7
Event Data Fields:

| Field | Field Description |
|---|---|
| [Some or all of the Fields of | [Same as Table A] |
| Table A described above] | |
| Number of New Active Contacts | Number of New contacts attributed |
| | to event |
| New Contact Score | Score based on number of new |
| | contacts attributed to event |
| Relationship Change Score | Score based on relationship score |
| | changes (e.g. Enterprise-Contact |
| | score changes) occurring within a |
| | defined duration after the event |
| Event ROI Score | ROI Score computed for event based |
| | on predefined model or criteria |
| Average Enterprise-Contact | Average Enterprise-Contact |
| Relationship Score | Relationship Score of attendees |
| Average Title Score | Average Title score of attendees |
| Opportunities Score | Score based on number of new |
| | opportunities and/or changes in the |
| | status of opportunities that can be |
| | attributed to event |

Data Object Storage and Collection: In example embodiments, the CRM support system 120 includes both current and historic records in data objects 124, enabling changes in data, including data of the type included in the data object fields noted above, to be compared and plotted over time. For example, current and historical time-stamped versions of the records (or selected data fields) included as data objects 124 may be stored at relationship data storage 122.

The data included in data objects 124 in relationship data storage 122 may be obtained by CRM support system 120 from different sources using different methods. For example, some information may be collected from enterprise users 182 through data entry provided through user interfaces supported by CRM support agent 114. Some information may be gathered from third party data providers (e.g., contact information and account information pertaining to inactive prospective accounts and contacts, and supplementary information regarding contacts 192 and accounts 190). Some information may be gathered directly or indirectly (for example via CRM agent 119) from CRM system 200. Some information may be received from event management system 290. Some information may be gathered through automated monitoring of enterprise network 110 activities and events by CRM support agent 114, such as email activities, calendar activities and personal information management system contact management activities. CRM support system 120 may be configured to perform periodic email, calendar and contact synchs with CRM support agent 114 for updates.

By way of example, in the case of activity data 32, in example embodiments, CRM support agent 114 is configured to automatically collect information about communication activities between users 182 associated with the enterprise 180 and external contacts 192 associated with an account 190. These communication activities may for example be electronic communications such as email, meetings that are tracked in calendar systems and/or scheduled through email communications, and telephone calls that occur through a system that enables call logging. Each of these interactions have associated electronic data that includes a contact identifier (e.g., email address or phone number for contact 192), time stamp information for the interaction, and a user identifier (e.g., data that identifies the member(s) 182 of the enterprise 180 that were involved in the interaction.

In example embodiments, CRM support agent 114 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, CRM support agent 114 may collect information from an enterprise mail server located within enterprise network 110 and or from calendar applications associated with enterprise network and users 182, via the connector 112.

In example embodiments, connecter 116 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, connector 116 may collect information from the mail server 112. For example, in some embodiments connector 116 is configured to intermittently run a batch process to retrieve email messages from the mail server 112 so that communication activity data can be derived from the email messages and provided through communication network 150 to the relationship database 122.

In some examples, the connector 116 is configured to extract selected information from email messages as contact interaction data. For each email message, the extracted information may for example include any external email address included in the sender, recipient and carbon copy (CC) and blind carbon copy (BCC) recipient email address fields, along with a send or receive timestamp applied to the email message by the mail server 112. In example embodiments, the extracted information can also include information that identifies any enterprise users 182 that are participating in the email as sender or recipient or CC recipient. In example embodiments, the extracted information can also include information that identifies any account members 192 that are participating in the email as sender or recipient or CC recipient.

In example embodiments, meeting requests and invites will be included among the email messages that are processed by mail server 112, and connector 116 is configured to include email addresses in the meeting invitee list and organizer fields in the contact interaction data extracted from the emailed meeting invite. In some examples, connector 116 may also be configured to communicate directly with calendar applications of users 182 within the enterprise network 110 to identify email addresses belonging to possible external contacts and include that information in communication activity data. In some examples where enterprise network 110 supports phone call logging, for example in Voice-Over-Internet-Protocol (VOIP) implementations, connector 116 may be further configured to interact with a VOIP server to collect information about external phone numbers used for outgoing and internal calls for inclusion in communication activity data.

In example embodiments, CRM support system 120 is configured to periodically update contact data 26 to add new contacts or update contact status (e.g., active/in-active indicator of contacts). In some examples, new contacts may be added or contact status updated based on information received directly or indirectly from CRM system 200 and/or marketing event management system 290. In some examples new contacts may be added or contact status updated based on information received from CRM support agent 114 based on activities that occur within enterprise network 110. For example, in the case of a new marketing event, an email may be sent to invitees through the mail server 112 of enterprise network. The email will be a communication event that is tracked by connecter 116 and reported to CRM support system 120. The activity record(s) 34 for the communication event will record the participants in the communication event. In cases where the invitees are not existing contacts, CRM support system 120 may be configured to create new contact ID's and new contact records for such invitees. In some examples, a new contact may be recorded by CRM support system based on information received from marketing event management system 290 about individuals who have registered for or attended an event, but who were not previously recorded as contacts. In such scenarios, the new contact may not, at the time of injection into contact data 26, have any existing relationships with individual users 182 of the enterprise 180.

Relationship Scoring

It will be noted that a number of the data objects 124 include relationship scoring information that assign values to relationships based on metrics described in greater detail below. The relationship scores include: account data 22 includes a “Top User-Account Relationship” that identifies the enterprise user 182 that has a highest overall relationship score with the subject account 190; contact data 26 includes a “Contact-Enterprise Relationship Score” that that indicates a perceived value of the relationship of enterprise 180 with the subject contact 192; user data 28 includes a “User-Account Relationship Score” that indicates perceived value of user's relationship with contact; and user-contact relationship data includes a “User-Contact Relationship Score” that indicates perceived strength of the user-contact relationship.

According to example embodiments, the CRM support system 120 is configured with a set of relationship score prediction models for computing each of the respective relationship scores. In at least some examples, these scores are calculated by CRM support system 120 based on communication activities between enterprise users 182 and account contacts 192, such as the communications activities that are tracked as part of activity data 32. By way of example, the user-contact relationship score for an enterprise user 182-account contact 192 could be based on a communication score that is based on features such as, among other things: activity type (e.g., incoming email, outgoing email, incoming meeting request, outgoing meeting request, incoming phone call, outgoing phone call, in-person meeting, on-line meeting, video conference); frequency (e.g., number of communication activities with a defined time period); recentness of communication activities; and length of communication activity, among other things.

By way of illustrative non-limiting example, a communication score based on frequency of communication, recentness of communication, and type of communication could be determined based on a pre-defined model or algorithm such as follows:

Raw communication score=(total number incoming emails in last week from contact listing user as direct or CC recipient)*(W1)+(total number outgoing emails in last week from user listing contact as direct or CC recipient)*(W2)+(total number of phone calls, in-person meetings, and virtual meetings involving both user and contact in last week)*(W3)+(total number incoming emails in last month from contact listing user as direct or CC recipient)*(W4)+(total number outgoing emails in last month from user listing contact as direct or CC recipient)*(W5)+(total number of phone calls, in-person meetings, and virtual meetings involving both user and contact in last month)*(W6)+(total number incoming emails in last 6 moths from contact listing user as direct or CC recipient)*(W7)+(total number outgoing emails in last six months from user listing contact as direct or CC recipient)*(W8)+(total number of phone calls, in-person meetings, and virtual meetings involving both user and contact in last week)*(W9)+(total number of all communications activities involving both user and contact over lifetime of user-contact relationship)*(W10)

Where: W1 to W2 are predetermined weights. (e.g., W1=W2=7; W3=8, W4=W5=5, W6=6; W7=W8=3; W9=4; W10=1).

In further example embodiments, the communication score may be determined using a learned model that has been learned using machine learning techniques based on historic communication and relationship data.

In example embodiments the raw communication score may be normalized to a communication score based on comparison with historical data and/or data for other user-contact relationships or other scaling methodology to a range (for example 0 to 1). In some examples, the normalization may be based on data limited to the enterprise. In some examples, the normalization may be based on data from an industry. In some examples, normalization may be related to a specific account. In some examples, a communication momentum value may be based on trends over time in the metrics represented in the raw score calculation noted above.

In some examples a User-Contact Relationship Score could be a composite of the contacts title score and a communication score based on the above attributes (e.g., contact title score*communication score). In some examples the User-Contact Relationship Score may be decided based only on the communication score. In some example embodiments, User-Contact Relationship Score could be represented as a discrete ranking within a relative scale such as “3=high”, “2=medium, “1=low”.

In some examples, “Contact-Enterprise Relationship Score” could be based on a combination (e.g., sum or product) of all of the individual User-Contact Relationship Scores that a contact 192 has with users 182 of enterprise 180. In some examples, a “User-Account Relationship Score” could be based on a combination (e.g., sum or product) of all of the individual User-Contact Relationship Scores that a user 182 has with account contacts 192. In some examples, the “Contact-Enterprise Relationship Score” could be based on a combination of all the individual User-Contact Relationship Scores across all user-contact relationships between an enterprise 180 and an account 190.

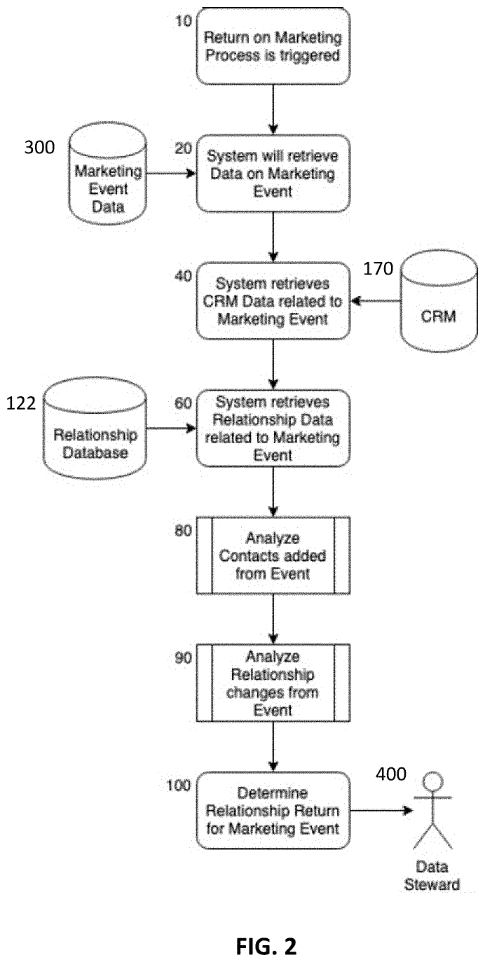

ROI Analysis Module: In example embodiments, the ROI analysis module 118 of the CRM support agent 114, retrieves contact and opportunity information from the CRM system 200, contact and account activity data from the relationship database 122, and marketing even data from the marketing event data storage 300, and then performs an event analysis after an event has occurred to compute one or more performance metrics, including for example a value that can be representative of the event ROI. FIG. 2 is a flow diagram illustrating the event analysis steps taken by the ROI analysis module 118 according to a first example embodiment.

Step 10: ROI analysis Triggered: In example embodiments, an event analysis by ROI analysis module 118 can be triggered to perform an event ROI analysis when an authorized individual or user 182 (e.g., a data steward 400) wishes to update information on Relationship ROI for one or more Marketing Events. In some example embodiments, ROI analysis module 118 is triggered at a pre-determined time after a marketing event has occurred. In some examples, an event analyses could be triggered on a regular scheduled basis. In some example embodiments, ROI analysis module 118 is triggered to perform an event analysis when a pre-determined number of new Marketing Events have been recorded. In some examples, the occurrence of any one, or of a predefined combination of, the above triggers could cause ROI analysis module 118 to perform an event analysis.

Steps 20, 40, 60: Data ingestion and retrieval: ROI analysis module 118 retrieves Marketing Event Data, contact data, relationship data, and opportunity data from one or more of marketing event data system 300, CRM database 170 and relationship database 122. For example, ROI analysis module 118 may retrieve marketing event data from marketing event data storage 300, and contact data from the CRM database 170 for contacts 192 that are attributed to the marketing event (e.g., invitees, registrants and attendees). Examples would be, but not limited to, invitees, registrants and attendees that are invited to, register for and attend a Webinar or a Breakfast Briefing. ROI analysis module 118 may also retrieve data from the Relationship Database 122 for all the Contacts identified in Step 40.

In at least some examples, the marketing event data stored in marketing event database 300, and information about accounts, contacts and opportunities stored in CRM database 170, is ingested into the data objects 124 of relationship data storage 122 as a precursor to the event analysis process of FIG. 2, and the ROI analysis module 118 relies on information included in the data objects 124 of relationship data storage 122 to perform ROI analysis. In such examples, the ROI analysis process can begin at step 60. In some examples, data retrieval steps (example step 60) may be integrated into the event performance analysis steps described below, with information being retrieved for accounts, opportunities, contacts, activities and events as required for the ROI analysis.

Step 80: New Contact Score Analysis: The ROI analysis module 118 analyzes the contact data from one or more of the above sources (for example relationship data storage 122 in the case where event data and contact data is ingested into CRM support system 120) to identify new contacts that can be attributed to the Marketing Event. In some examples, this can be done by comparing the list of event invitees, registrants and attendees at the time of ROI analysis (e.g., at a selected or pre-defined defined time after the marketing event) with historic contact information from before the marketing event (and/or before the sending of invitations for the marking event). Contacts included in the invitees, registrants and attendee lists that have been added as contacts to the system (e.g., to contact data 26) in the duration between the marketing event and the analysis can be counted as “New Contacts”. In some examples, pre-existing contacts that have had a change in status from in-active to active attributed to the marketing event may also be counted as new contacts, or may be measured using a different metric. In example embodiments, the ROI analysis module 118 will assign a New Contact Score for the event based on number of new contacts created. This New Contact Score may in some embodiments be adjusted by a number of factors including, but not limited to, company size (e.g., annual revenue or number of employees (e.g., Account Size Score) and/or Title Score of the new contacts made. This may result in a marketing event that brings in a higher quantity of new contacts getting a lower New Contact Score than a different marketing event that adds fewer, but higher positioned, new contacts.

Accordingly, in a first illustrative embodiment, a New Contact Score for an event can simply be the number of new contacts attributed to the event (e.g., Total Number of New Contacts Score). In a further illustrative embodiment, a New Contact Score for an event may be the sum of the Title Scores for all the new contacts attributed to the event (e.g., Position/Seniority Biased New Contact Score). In yet a further illustrative embodiment, a New Contact Score for an event may be the sum of the product of the Title Score and Account Size Score for all the new contacts attributed to the event (e.g., Position/Seniority and Account Size Biased New Contact Score). In some examples, each of the above New Contact Score metrics could be computed for an event.

Step 90: Relationship Change Score Analysis: The ROI analysis module 118 determines a Relationship Change Score for an event based on relationship changes (positive or negative) that have occurred from the time of the marketing event until the time that the ROI analysis is performed. In at least some examples, this change is determined both for new contacts that are attributed to the event as well as for any pre-existing active contacts that were associated with the marketing event (e.g., contacts that were included in one or more of the invitee, registrant and attendee lists). In particular, as noted above, in example embodiments, the contact data 26 include a Contact-Enterprise Relationship Score for all tracked contacts 192. In an example embodiment, the ROI analysis module 118 determines, based on historical relationship scoring information, a total sum of the individual Contact-Enterprise Relationship Scores for all contacts included in the event attendee list for a date prior to the marketing event, and then repeats the calculation using current data available when the ROI analysis is performed. The difference between the before and after totals of Contact-Enterprise Relationship Scores for all contacts included in the event attendee list provides the Relationship Change Score.

As noted above, in example embodiments, the Contact-Enterprise Relationship Score for a particular contact 192 is based at least in part on number, frequency and recentness of communications events involving the contact 192 and enterprise users 182. Accordingly, in example embodiments, the Relationship Change Score is indicative of the effectiveness of a particular event in generating on-going follow-on communications with the attendees, which can be representative of the value and strength of the contact relationships. In some examples, the relationship change values may also be extended to include event invitees and registrants that did not actually attend the event, as knowledge about relationship changes with such individuals may be indicative of the goodwill (or lack there off) in promoting a particular type of event.

Accordingly, in example embodiments, the ROI analysis module 118 will compute a Relationship Change Score for an event based on the Relationship Changes for existing Contacts that participated in the marketing event and relationship improvements for the new Contacts added as a result of the Marketing Event.

Step 100: Relationship ROI Score: In example embodiments, ROI analysis module 118 will calculate a Relationship ROI Score for the subject marketing event. In some examples embodiments, Relationship ROI Score is a composite value that is computed based on a combination of event performance metrics such as the New Contact Score from Step 80 and the Relationship Change Score from Step 90. For example, the model for determining Relationship ROI Score for an event may be based on determining a product of the New Contact Score and the Relationship Change Score for an event.

As indicated in Table 7 above, other event performance metrics that may be computed in respect of an event include an Average Enterprise-Contact Relationship Score of attendees, Average Title Score of attendees, and an Event Opportunity Score. The Event Opportunity Score may be a score that that is based on the number of, and attributes of opportunities that have a change of status that can be attributed to the event, including for example, one or more of: (i) new opportunities that can be attributed to event; (ii) changes in the opportunity phases of both pre-existing and new events that can be attributed to the event; and (iii) number of successfully closed opportunities that can be attributed to the event. By way of example, ROI analysis module 118, may be configured to determine, based on Opportunity Data 24 and Contact Data 26 what new opportunities, opportunity phase changes, and successfully closed opportunities can be attributed to an event by determining which events were attended by contacts 192 that are participants in pre-existing or recently added opportunities, and then comparing the opportunity data for such opportunities at the time of the analysis to the historic data that predated the event. By way of not limiting example, an Event Opportunity Score may be computed by the model: (i) (number of new opportunities that can be attributed to event)×(average increase in phase levels changes for opportunities that can be attributed to the event)×(average Opportunity Size Score of all successfully closed opportunities that can be attributed to the event).

Accordingly, in some examples, Relationship ROI score may also be based on information on Opportunities that are associated with contacts that participated in the marketing event.

In at least some examples, the ROI analysis module 118 will compute event preference information for one or more of: (i) individual contacts, (ii) contacts having the same or similar positions and/or title scores falling within defined ranges, and (iii) contacts in defined types of industries. In the case of individual contacts, ROI analysis module 118 may for example determine an event preference by determining, based on the event attendee lists for historic events, the event type an individual contact has attended most often. For example, a target contact may have attended different event types as follows: 4 Webinars, 2 Wine'n'Cheese and 1 Round table. In such a case, where the ROI analysis module 118 applies a predefined rules (e.g. a preference model) that identifies “most attended event type”, it may be determined that the target contact has a preference for event type “Webinar”.

In some example preference may be defined by additional criteria than just events attended, and may for example also be based on event invitations. For example, based on event invitee and event attendee lists, ROI analysis module 118 may determine that the number of events attended to invitations for a target contact for different event types is: Webinars: 4 for 16; Wine'n'Cheese: 2 for 3; Round table: 1 for 8. In such a case, where the ROI analysis module 118 applies a preference model that identifies “highest proportion of attendance to invites”, it may be determined that the target contact has a preference for event type “Wine'n'Cheese”. In some cases the ROI analysis module 118 applies a preference model that is based on a combination of metrics that are indicative of preference. For example, the event attendance could be weighted according to both event invitations and event registrations for the target contact. Once a target contact's event preference type is computed, ROI analysis module 118 can cause the preference information to be stored. In some examples, ROI analysis module 118 may directly or indirectly cause the “Preferred Marketing Event” field of the contact data 26 stored at relationship database 122 for the target contact to be updated with the computed target contact's event preference type.

In example embodiments, ROI analysis module 118 computes industry preferences based on a predetermined industry preference model that uses a combination of the individual event preferences of the individual contacts in that industry (as identified by the account industry codes mapped to each of the contacts in relationship data storage 122). Such an industry preference model may for example be based on an averaging or other combination of the preference metrics described above in respect of individual contact preferences.

In example embodiments, ROI analysis module 118 computes position/title event preference types based on a predetermined title-based preference model that combines the preference information of individuals that have similar positions or titles. In some examples, contacts with the same or similar positions are identified based on similarities in the information included in the position/title fields of contact data 26. In some example, contacts with the same or similar positions are identified based on a similarity of title scores included in contact data 26 (e.g. title scores that fall within a defined range). In example embodiments, the title-based preference model may be based on an averaging or other combination of the individual preference metrics described above in respect of individual contact preferences.

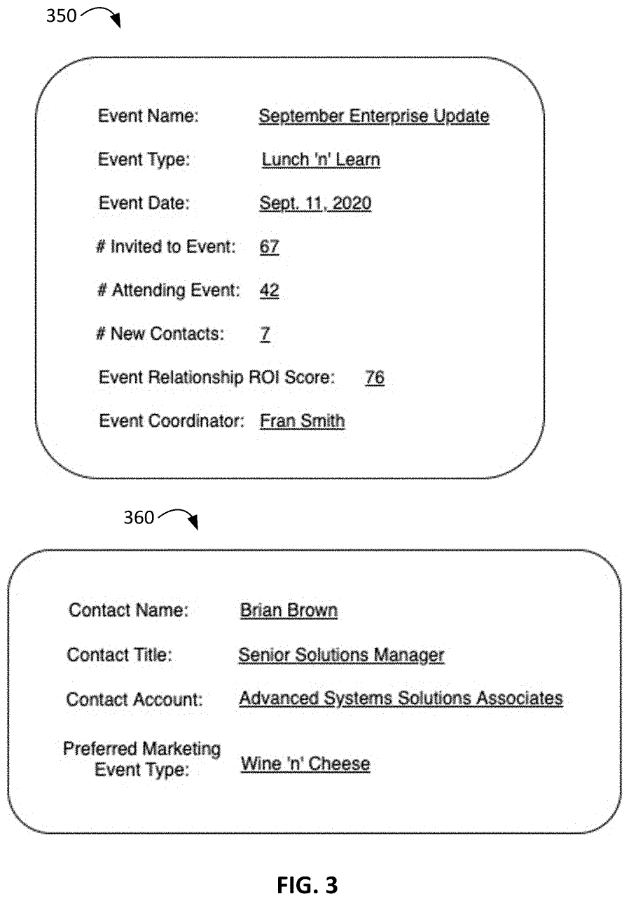

In some examples, the computed Relationship ROI information and event preference information, and other computed event metrics, are presented to a Data Steward 400. In this regard, FIG. 3 illustrates an example of an event report 350 and a contact preference report 360 that may be presented using a display device or other output device to a user such as data steward 400.

In example embodiments, the ROI analysis module 118 causes the computed event performance metrics, industry event type preference and position/title event type preference (and other metrics illustrated in Table 7) to be stored for future reference. In some example's, this information can be stored at databases hosted at one or more of enterprise network 110, event management system 290 and CRM support system 120 (e.g., as a data object 124 in relationship data storage 122).

Although the models used to compute event performance metrics are described above as rules based models, in at least some examples one or more of the models may be substituted with machine learning based models that may be learned using machine learning techniques that may for example, be based on historical data.

In example embodiments, a Data Steward 400 may use the information computed by the ROI analysis module 118 for various purposes, including, but not limited to: (i) determine which type of marketing event a specific contact would be most likely to attend; (ii) determine which type of marketing event a specific industry sector would be most likely to attend; (iii) determine which type of marketing event a person having a specific position/title score would be most likely to attend; (iv) determine the relationship ROI for a one type of event (e.g., Wine'n'Cheese event) and compare it to the relationship ROI for a second type of event (e.g., Breakfast Briefing) to determine which event should be scheduled; (v) determine the best marketing event (based on relationship ROI) to use for a different types of marketing projects, e.g., a product launch, a partner enablement, a new vertical entry or a fundraiser; (vi) determine the best type of marketing event to generate new contacts; (vii) determine the best type of marketing event to use to increase existing contact relationship scores; and (viii) determine which type of marketing event a person having a specific enterprise-account relationship strength would be most likely to attend.

Applications of this solution could, for example include: A Law Firm that hosts an annual Open House could apply this solution to determine the Relationship ROI on the event; A Law Firm could apply this solution to determine which Marketing Event a Contact is most likely to attend event; A Sales organization could apply this solution to determine the Relationship ROI on a Wine and Cheese event and compare that with Relationship ROI on a Breakfast Briefing event; A Sales organization could apply this solution to determine the best Marketing Event (based on Relationship ROI) for use as a Product Launch, a partner enablement, a new vertical entry or a fundraiser; A Sales/Marketing organization could apply this solution to determine the Relationship ROI on various different types of Marketing Events in order to best serve their clientele with a Marketing Event focused on improving the specific facet that their Client would like improved, for example a specific type of Marketing Event to generate new Contacts versus another Marketing Event type aimed at improving existing Relationship Strengths with Contacts.

An overview having been provided, further details and features of the disclosed methods and systems will now be explained according to example embodiments.

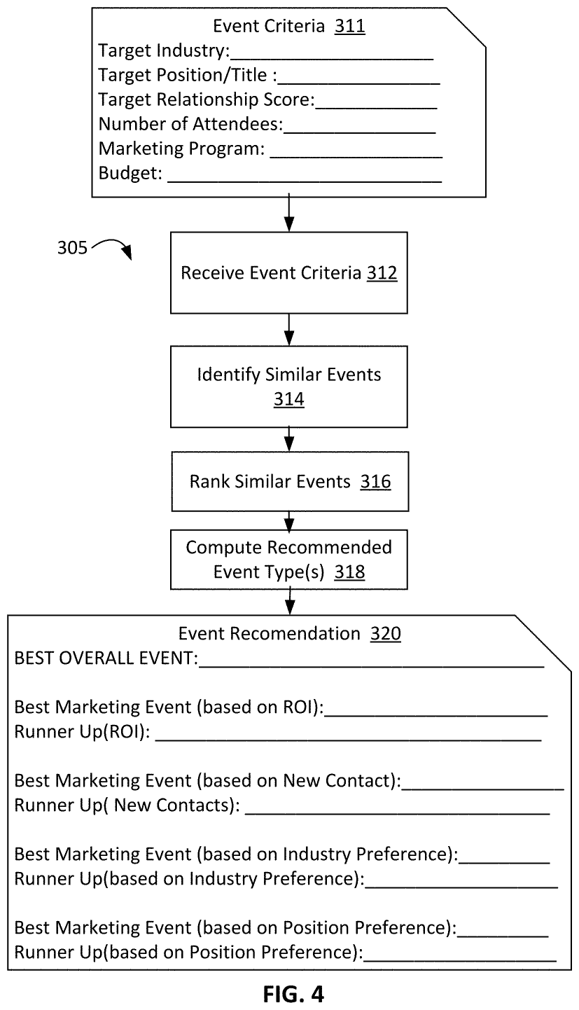

In example embodiments, ROI analysis module 118 is configured to generate recommendations for future events based on a set of input target event attributes. A recommendation generation process 305 is illustrated in FIG. 4. In the example of FIG. 4, as indicated at block 312, ROI analysis module 118 receives, as input, event criteria 311 that specifies a plurality of target attributes for an event. In example embodiments, the target attributes can be selected from any of the attributes included in the fields that are tracked in the event records that are stored at marketing event database 300 or in the data objects 124 of relationship data storage 122. In example embodiments, ROI analysis module 118 is configured to generate a user interface to enable a user 182, for example data steward 400 or other enterprise user, to input the event criteria. In the illustrated example, the target attributes that make up event criteria 311 includes 6 attributes, namely: One or more Target Industries (e.g., can specify target industry(ies) for the event, can be mapped to Standard Industrial Classification (SIC) Code and/or North American Industry Classification System (NAICS) Codes, and corresponds to Account Industry Code field in account data 22); Target Position/Title (can indicate a range (e.g., a minimum level, a maximum level, or maximum and minimum levels) of position of target attendees that the event is intended to target, e.g., IT manager or Director, can be mapped to similar positions in contact data 26 or to a title score that corresponds to Title Score field of contact data 26); Target Relationship Score Range (can specify a range, e.g., a minimum Contact-Enterprise Relationship Score or a maximum minimum Contact-Enterprise Relationship Score (or both a minimum and a maximum) for target attendees, corresponds to Contact-Enterprise Relationship Score field of contact data 26); Number of Attendees (may be specified as a range, e.g., 50 to 100, corresponds to Number of Attendees field in event data 36); Marketing Program (specifies the type of project that the event coincides with, e.g., general contact building or product launch, corresponds to Project Type field for event stored in one or both of marketing event database 300 or event data 36; and Budget (can specify target budget for event, may be a range, e.g., $10K to $15K, corresponds to Event Cost field for event stored in one or both of marketing event database 300 or event data 36).

The event criteria 311 shown in FIG. 4 and described above are illustrative, and in example embodiments the number of event criteria is user configurable. For example, the data steward 400 may limit the target event criteria attributes to a subset of the attributes shown in FIG. 3, or may increase the number of event criteria. In example embodiments, the user interface generated by ROI analysis module 118 enables the user/data steward 400 to select what types of event filtering/similarity attributes are used to select similar events. For example, event filtering/similarity attributes may be limited to Target Industry and Target Position/Title.

As indicated in block 314, ROI analysis module 118 is configured to identify historic events that meet the similarity/filtering criteria specified in the event criteria 311. Such events can be identified based in the information included in relationship database 122 and, in some cases, in marketing event database 300 (e.g., if the information included in marketing event database 300 records is not also included in event data 36 of relationship database 122).

As indicated in block 316, ROI analysis module 118 is configured to rank the events that have been selected in block 314 in categories that correspond to predefined event performance criteria. The event performance categories and the criteria used for ranking events in such categories can be different in different embodiments, may in some examples be user-configurable, and in some examples multiple ranking lists can be generated, with events ranked by a different event performance criteria in each of the lists. For example, possible event performance ranking categories can include: ranking by Event ROI Score; ranking by New Contact Score; ranking by Relationship Change Score; ranking by Industry Preference; ranking by Position/Title (e.g., title score) preference; ranking by number of new opportunities. In some examples, composites of different metrics may be used as performance criteria, For example, performance criteria based on a combinations of the above criteria and/or other criteria, may be used. For example, rankings lists could be generated for one or more of the above criteria relative to event cost (e.g., total number of new contacts/event cost)

As indicated in block 318, ROI analysis module 118 is configured to apply a predefined set of rules or a predefined model to rank the event types based on the top ranked events included in each of the ranked event list generated in block 316. For example, events ranked by ROI Score may be further analyzed to determine if a particular type of event dominates the top rankings in one or more of the ranking categories noted above. For example, in an illustrative, non-limiting example the ROI analysis module 118 is configured to compute an event type score for each of the event types of events included in the event ROI score ranking list. The event type score for each event type could be calculated as follows:

Event Type Score=(Number of Occurrences of events of the Event Type in the top N spots of events in Ranking List)*(N*N−sum of the rankings of the events of the Event Type in the top N spots of events in Ranking List).

Accordingly, in the above example the Event Type Score is based on the number of times an event type appears in an event ranking list and the relative position (e.g., ranking) of the events of the event type in the list, such that higher ranked events are given more weight when determining the event type score.

Event type scores based on other ranking lists, for example New Contact Score, Relationship Change Score, New Opportunities Generated, Industry Preference and Position/Title Preference could also be determined in a similar weighted matter.

In some examples, a Composite Best Overall Event Score could be determined based on a composite of the rankings in the individual categories.

In some example embodiments, machine learning based models may be learned to predict outputs for some or all of the event categories, and for a best overall event category, using machine learning techniques that may for example, based on historical event data.

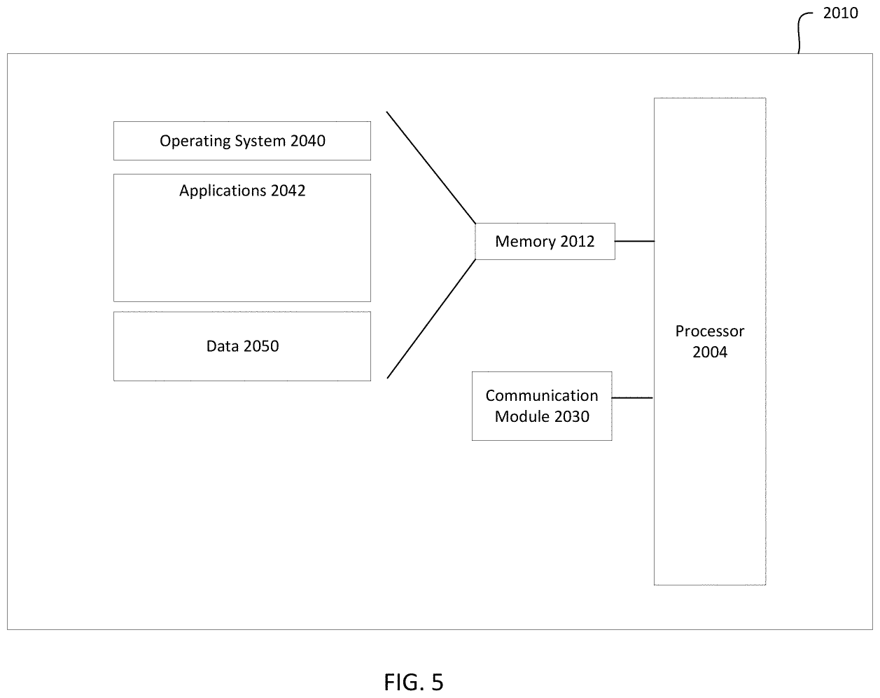

Referring to FIG. 5, an example embodiment of a computer system 2010 for implementing one or more of the modules, systems and agents included in enterprise network 110, CRM system 200, CRM support system 120, and even management system 290 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 2042 executed by the processor 2004 are also stored in the persistent memory. The applications 2042 can include software instructions for implementing the systems, methods, agents and modules described above.

The system 2010 is configured to store data that may include data objects 124 and customer data, in the case of CRM support system 120.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method for determining one or more performance metrics for events that an enterprise participates in, comprising:
receiving data identifying individual contacts that attended an event;
computing, for each of the individual contacts, a difference in an individual relationship score for the individual contact at a time following the event relative to a time preceding the event, wherein the individual relationship score is based on automated tracking of communication activities occurring between the individual contact and individual users associated with the enterprise;
computing a first event performance metric for the event based on the computed differences in the individual relationship scores for the individual contacts; and
storing the first performance metric for the event.

2. The method of claim 1 comprising:
identifying which of the individual contacts that attended the event are new contacts that can be attributed to the event;
computing a new contact score for the event based on the identified new contacts.

3. The method of claim 2 wherein the new contact score is computed based on both a total number of the identified new contacts and on positions of the identified new contacts within their respective organizations.

4. The method of claim 2 wherein the first performance metric is indicative of a perceived return on investment of the event and is computed also based on the new contact score.

5. The method of claim 2 wherein the first performance metric corresponds to a relationship change score, the new contact score corresponds to a second performance metric for the event; and the method comprises computing and storing a third performance metric indicative of a perceived return on investment of the event based on the relationship change score and the new contact score computed in respect of the event.

6. The method of claim 1 wherein the method comprises identifying, based on information about ongoing opportunities of the enterprise that are stored in a database, which of the opportunities are associated with individual contacts that attended the event, determining changes in a status of the identified opportunities following the event, and computing an opportunity score based on the determined changes.

7. The method of claim 1 wherein the method further comprises:
receiving a set of event attributes in respect of a proposed future event;
computing, based on (i) event data for a plurality of historic events that includes one or more performance metrics for each of the historic events and event type information for each of the historic events; and (ii) the set of event attributes, a recommended event type for the proposed future event.

8. The method of claim 1 comprising computing, based on event data for a plurality of historic events, event types that are preferred by contacts within different industry classifications, and computing a recommended event type for a proposed future event based on an indicated target industry classification for the proposed future event.

9. The method of claim 1 wherein the events include one or more of: marketing events that are organized by the enterprise, and third party events that individual users associated with enterprise participate in.

10. The method of claim 1 comprising automatically monitoring occurrences of electronic communications between individual users and the individual contacts over time to track the communication activities occurring between the individual contacts and the individual users.

11. A system for determining one or more performance metrics for events that an enterprise participates in, the system comprising a processor and non-transitory storage medium coupled to the processor, the storage medium storing software instructions that when executed by the processor configure the system to:
receive data identifying individual contacts that attended an event;
compute, for each of the individual contacts, a difference in an individual relationship score for the individual contact at a time following the event relative to a time preceding the event, wherein the individual relationship score is based on automated tracking of communication activities occurring between the individual contact and individual users associated with the enterprise;
compute a first event performance metric for the event based on the computed differences in the individual relationship scores for the individual contacts; and
store the first performance metric for the event.

12. The system of claim 11 wherein the system is configured to:
identify which of the individual contacts that attended the event are new contacts that can be attributed to the event;
compute a new contact score for the event based on the identified new contacts.

13. The system of claim 12 wherein the new contact score is computed based on both a total number of the identified new contacts and on positions of the identified new contacts within their respective organizations.

14. The system of claim 12 wherein the first performance metric is indicative of a perceived return on investment of the event and is computed also based on the new contact score.

15. The system of claim 12 wherein the first performance metric corresponds to a relationship change score, the new contact score corresponds to a second performance metric for the event; and the system is configured to compute and store a third performance metric indicative of a perceived return on investment of the event based on the relationship change score and the new contact score computed in respect of the event.

16. The system of claim 11 wherein the system is configured to identify, based on information about ongoing opportunities of the enterprise that are stored in a database, which of the opportunities are associated with individual contacts that attended the event, determining changes in a status of the identified opportunities following the event, and computing an opportunity score based on the determined changes.

17. The system of claim 11 wherein the system is configured to:
receive a set of event attributes in respect of a proposed future event;
compute, based on (i) event data for a plurality of historic events that includes one or more performance metrics for each of the historic events and event type information for each of the historic events; and (ii) the set of event attributes, a recommended event type for the proposed future event.

18. The system of claim 17 wherein the system is configured to implement a machine learning based model that has been trained to compute the recommended event type.

19. The system of claim 11 wherein the system is configured to automatically monitor occurrences of electronic communications between individual users and the individual contacts over time to track the communication activities occurring between the individual contacts and the individual users.

20. A computer readable medium that persistently stores software instructions that when executed by a processor configures a system that incorporates the processor to:
receive data identifying individual contacts that attended an event;
compute, for each of the individual contacts, a difference in an individual relationship score for the individual contact at a time following the event relative to a time preceding the event, wherein the individual relationship score is based on automated tracking of communication activities occurring between the individual contact and individual users associated with the enterprise;
compute a first event performance metric for the event based on the computed differences in the individual relationship scores for the individual contacts; and
store the first performance metric for the event.
